(19) United States
(12) Patent Application Publication
(10) Pub. No.: US 2009/0031799 A1
(43) Pub. Date: Feb. 5, 2009

(54) Float diagnostics for level measurement

(75) Inventor: John S. Benway, Northbrook, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Magnetrol International, Inc.

(21) Appl. No.: 11/888,052

(22) Filed: Jul. 31, 2007

(51) Int. Cl. G01F 23/30; G01F 23/72

(52) U.S. Cl. 73/306

(57) ABSTRACT

A float level sensing system comprises a float and an elongated probe for sensing position of the float. The float is mounted proximate the probe so that the float floats atop the process material. The float drops outside a sensing range of the probe responsive to a failure of the float. A sensing circuit is operatively associated with the probe for measuring a characteristic of the probe representing position of the float and is operative to indicate a fault condition if the float is outside of the sensing range of the probe.

### CROSS REFERENCE TO RELATED APPLICATIONS

There are no related applications.

### FIELD OF THE INVENTION

The present invention relates to level sensing instruments and, more particularly, to float diagnostics.

### BACKGROUND OF THE INVENTION

Sensing instruments are used for sensing various different process variables, such as level of a process fluid or material in a process vessel. Many such instruments are of the intrusive type in which a sensing apparatus is exposed to the process material for sensing level. A common technique for measuring level uses a float. A float is an independent device designed to always stay on the surface of the material being measured. The level measurement is made by determining the location of the float. Floats also can be designed to settle at the interface between two materials where the top material is not gaseous. For instance, a float can be designed to stay at the interface between oil and water.

A float can be constructed with an internal magnet. The location of the float is determined by sensing the magnetic field from the float. One technology used to sense the magnetic field of a float is magnetostriction. The term magnetostriction refers to the tendency of some materials to change physically in the presence of a magnetic field. Magnetostrictive devices consist of a wire of magnetostrictive material. The wire is contained in a tube, or waveguide. The float can either surround the waveguide or be located in the vicinity of the waveguide. An electrical pulse is applied to wire. When the pulse reaches the magnetic field of the float the wire twists generating a strain pulse that travels back up the wire at the speed of sound. A pickup sensor at the end of the wire senses the return signal. The time between the generation of the electrical pulse and the return of the strain pulse is a measure of the distance to the float. This time measurement is typically done by a combination of analog and digital electronics attached to the wire. These electronics may include a microprocessor that makes the time measurement, converts it into a distance, and finally into a level. The electronics can use two wires, four wires or digital communication.

Many applications for level measurement exists in the process industry. Some of these applications have safety requirements defined by industry standards such as IEC 61508 and IEC 61511. These standards describe methods to measure the appropriateness of devices, such as level transmitters, for these applications. One such method uses the calculation of the Safety Integrity Level (SIL). The higher the SIL value, the lower the likelihood a dangerous undetected fault will occur. An important aspect of determining the appropriateness is the ability of the device to determine and indicate the difference between an actual measurement and a false measurement. In the case of magnetostrictive level devices the float is measured at the end of the waveguide when the level is at or below the end of the waveguide. A float will also stop at this point if it collapses or ruptures and fills with the material that is being measured. The level of the material can now rise above this point but the float will not rise to the surface. The result is an incorrect indication of the level which could result in material overflowing the vessel. The possibility of such a condition lowers the achievable SIL and such an event could have significant safety implications.

The present invention is directed to overcoming one or more of the problems discussed above in a novel and simple manner.

### SUMMARY OF THE INVENTION

In accordance with the invention there is described a float level sensing system for measuring level of a process material and including float diagnostics.

In accordance with one aspect of the invention a float level sensing system comprises a float and an elongated probe for sensing position of the float. Means are provided for mounting the float proximate the probe so that the float floats atop the process material. The mounting means enables the float to drop outside a sensing range of the probe responsive to a failure of the float. A sensing circuit is operatively associated with the probe for measuring a characteristic of the probe representing position of the float and is operative to indicate a fault condition if the float is outside of the sensing range of the probe.

In accordance with one aspect of the invention the float comprises a magnetic float and the probe senses a magnetic field of the float. The probe may comprise a magnetostrictive wire and a tube having a near end and a distal end supporting the wire. The mounting means may comprise the float being carried on the tube and a distal end of the wire is spaced from the distal end of the tube so that if the float is at the distal end of the tube it is out of the range of the wire.

In accordance with another aspect of the invention the mounting means comprises a chamber receiving the float and supporting the probe and wherein the chamber extends below the probe so that if the float is at the lower end of the chamber the float is out of range of the probe.

There is disclosed in accordance with another aspect of the invention a float level sensing system for measuring level of a process material and including float diagnostics, comprising an elongated probe for sensing a magnetic field. The probe has a near end and distal end and defines a select sensing range ending at an intermediate position between the near end and distal end. A magnetic float is carried on the probe between the near end and the distal end so that the float floats atop the process material. The float drops outside the select sensing range of the probe responsive to a failure of the float. A sensing circuit is operatively associated with the probe for measuring a characteristic of the probe representing position of the float and is operative to indicate a fault condition responsive to the float being outside the select sensing range of the probe.

There is disclosed in accordance with a further aspect of the invention a float level sensing system for measuring level of a material in a process vessel and including float diagnostics comprising a chamber for mounting to the process vessel and having an elongated interior space receiving the material. A magnetic float in the chamber floats atop the material. The float drops to a bottom portion of the chamber responsive to a failure of the float. An elongated probe is mounted to the chamber for sensing a magnetic field. The probe has a near end and a distal end. The distal end is above the bottom portion of the chamber so that the bottom portion is outside a select sensing range of the probe. A sensing circuit is operatively associated with the probe for measuring a characteristic of the probe representing position of the float and is operative to indicate a fault condition responsive to the float being outside the select sensing range of the probe.

Further features and advantages of the invention will be readily apparent from the specification and the drawings.

### BRIEF DESCRIPTION OF THE DRAWINGS

FIG. 1 is a perspective view of a level measuring system in accordance with one embodiment of the invention;

FIG. 2 is an elevation view of the float level system of FIG. 1;

FIG. 3 is a block diagram for a sensing circuit of the float level system;

FIG. 4 is a flow diagram illustrating a program implemented in the microprocessor of FIG. 3;

FIG. 5 is a perspective view of a float level sensing system according to another embodiment of the invention;

FIG. 6 is an elevation view the level sensing system of FIG. 5.

### DETAILED DESCRIPTION OF THE INVENTION

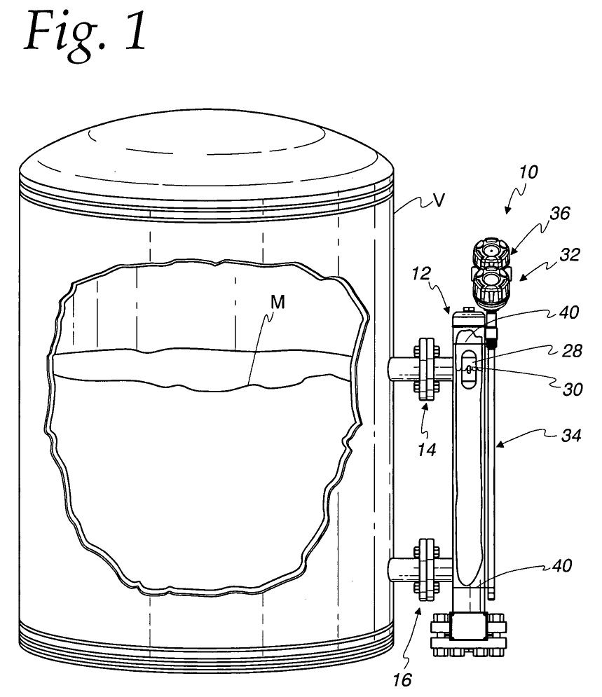

Referring to FIG. 1, a float level sensing system 10 for measuring level of a material M in a process vessel V includes float diagnostics in accordance with the invention.

The float level sensing system 10 comprises a chamber or cage 12 for fluidic coupling to the vessel V via a first horizontal pipe coupling 14 near the top of the vessel V and a second horizontal pipe coupling 16 near the bottom of the vessel V. Although not shown, the vessel V can be isolated from the chamber 12 using valves or the like.

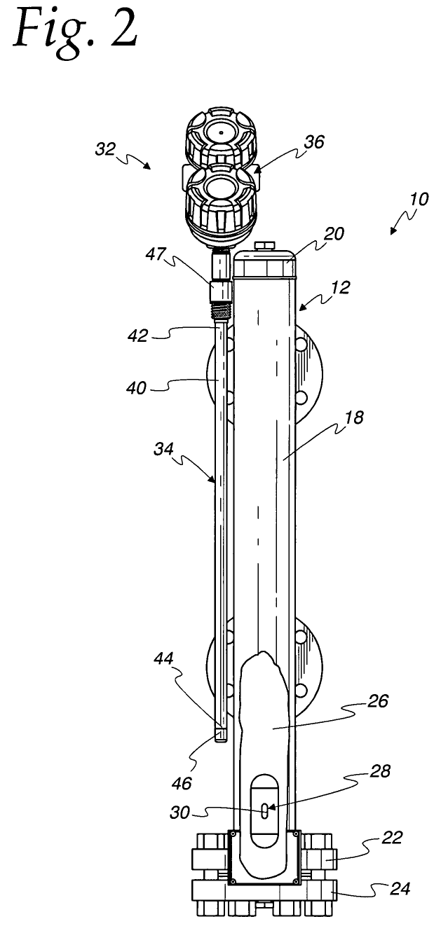

Referring also to FIG. 2, the chamber 12 comprises an elongated pipe 18 closed at a top end by a cap 20 and having a bottom flange 22 coupled to a bottom cover 24 to define an interior space 26. The described arrangement allows the material level in the vessel V to equalize with the level in the chamber 12, as illustrated in FIG. 1, while largely isolating the chamber 26 from agitation, mixing or other activities in the vessel V.

The float level sensing system 10 comprises a float 28 in the chamber space 26. The float 28 rides up and down in the chamber 12 at the surface of the material M. The float 28 is typically hollow so that it rides freely on the surface of the material M. The float 28 may be made of stainless steel or the like and houses a magnet 30 adapted to be positioned at the surface of the material M. As such, the float 28 is also referred to herein as a magnetic float. The float 28 is sized and weighted for the specific gravity and pressure of the application.

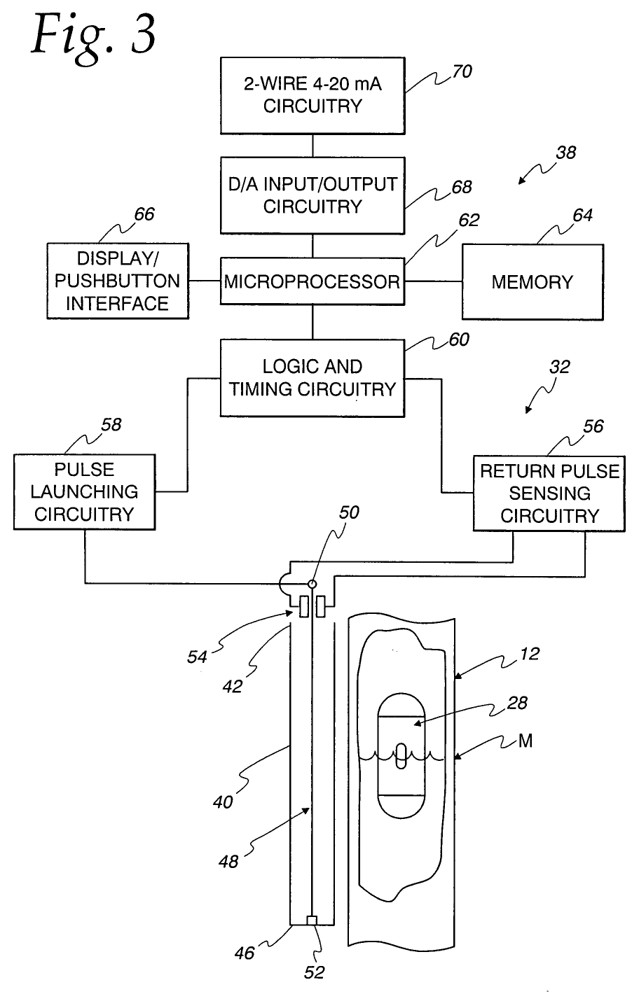

The float level sensing system 10 includes a level transmitter 32 for measuring position of the float 28 representing level of the material M in the vessel V. The transmitter 32 comprises a measurement instrument including a probe 34 connected to a housing 36 containing a sensing circuit 38, see FIG. 3. Straps 40, or the like, mount the transmitter 32 to the chamber 12.

In the illustrated embodiment to the invention, the transmitter 32 comprises a magnetostrictive level transmitter. The housing 36 comprises a dual compartment instrument housing as described in Mulrooney et al. U.S. Pat. No. 6,062,095. The probe 34 comprises an elongated stainless steel tube 40 having a near end 42 and a distal end 44. The distal end 44 is closed by an end cap 46. A coupling 47 mounts the housing 36 to the probe 34 at the near end 42. Referring also to FIG. 3, a magnetostrictive wire 48 has a first end 50 and a second end 52. The wire second end 52 is secured by a fixture or the like (not shown) in a conventional manner proximate the end cap 46. The wire first end 50 is electrically connected to the sensing circuit 38. A return wire (not shown) may be connected to the wire second end 52 and the measuring circuit 38. Alternatively, the tube 40 may be used as a return, as is known.

A pickup sensor 54 is positioned proximate the tube near end 42 or in the housing 36 and is connected to a return pulse sensing circuit 56. The magnetostrictive wire 48 is connected to a pulse launching circuit 58. The circuits 56 and 58 are connected to a logic and timing circuit 60 which is in turn connected to a microprocessor 62. The microprocessor 62 is also connected to a memory 64, a display/push button interface 66 and an I/O circuit 68 which drives a two wire 4-20 mA interface circuit 70. The interface circuit 70 is conventional and not described herein. As is known, power to the transmitter 32 is received on the two wire connection to the interface circuit 70.

The basic operation of the transmitter 32 is as follows. The microprocessor 62 periodically commands the logic and timing circuit 60 to drive the pulse launching circuit 58 to generate a pulse applied to the wire 48. When the pulse reaches the magnetic field of the float 28 the wire twists, as is known, generating a strain pulse that travels back up the wire at the speed of sound. The pickup sensor 54 senses the return signal, as determined by the return pulse sensing circuit 56. The time between the generation of the electrical pulse and the return of the strain pulse is measured by the logic and timing circuitry 60 and the microprocessor 62. The microprocessor makes the time measurement, converts it into a distance and finally into a level which can be displayed and/or transmitted to external devices via the interface circuit 70.

In accordance with the invention, the float level sensing system 10 includes float diagnostics. Particularly, in accordance with the first embodiment to the invention, the probe 34 is mounted to the chamber 12, as shown in FIG. 2, with the probe distal end 44 being spaced above the chamber bottom flange 22. Particularly, the spacing is sufficient so that the magnetostrictive wire is above the float 28 when the float is at its lowest position, as generally illustrated in FIG. 2. More particularly, the probe distal end 44 would be at a position representing the lowest level to be used in the vessel V. The chamber 12 extends below this point. Thus, under normal conditions, the float 28 will never drop below the probe distal end 44 as the level in the chamber 12 should not drop below such a level. However, if the float 28 collapses or ruptures and fills with the material M it will drop to the bottom of the chamber 12 so that it will no longer be sensed. The transmitter 32 is adapted to sense such a condition and indicate a fault.

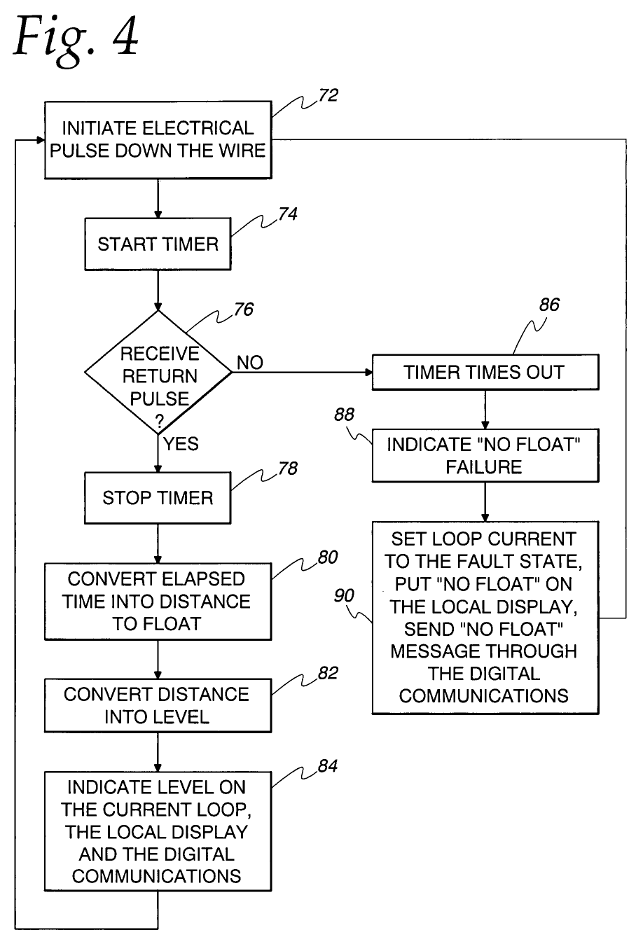

Referring to FIG. 4, a flow diagram illustrates operation of a program implemented by the microprocessor 62 for level measurement and float diagnostics. The routine begins at a block 72 which initiates an electrical pulse down the wire 48, as described. A block 74 starts a timer. A decision block 76 determines if a return pulse has been received. If so, then the timer is stopped at a block 78. The elapsed time is converted into distance to float at a block 80. The distance is converted to level at a block 82. The level is indicated on the current loop, the local display and any digital communications at a block 84.

Returning to the decision block 76, a block 86 determines if the timer has timed out. If not, then control returns to a block 76 to continue waiting for a return pulse. If the timer does time out, indicating that the distance would be greater than the sensing range of the probe, a block 88 indicates a no float failure. This happens if the float 28 is out of the range of the probe 34, as discussed above. A block 90 then sets the loop current to the fault state, indicates no float on the local display and sends a “no float” message through digital communications. Control then returns to block 72 for the next measuring cycle.

Thus, rather than simply indicating that the tank level is at the lowest level, the float diagnostics provide an indication that the float is no longer being sensed and the level measurement is not reliable.

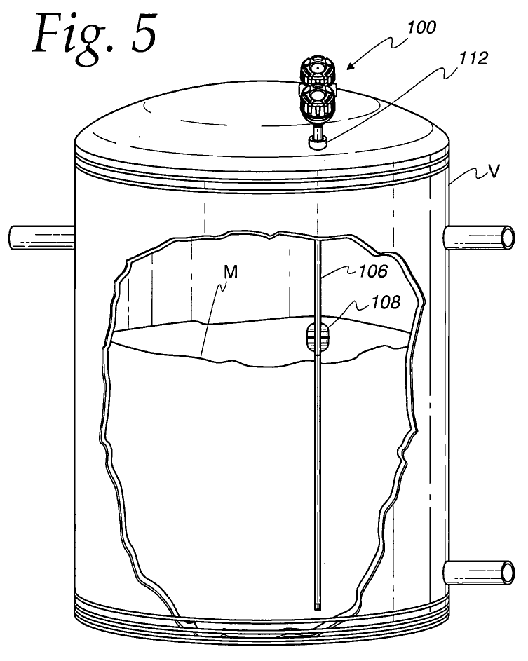

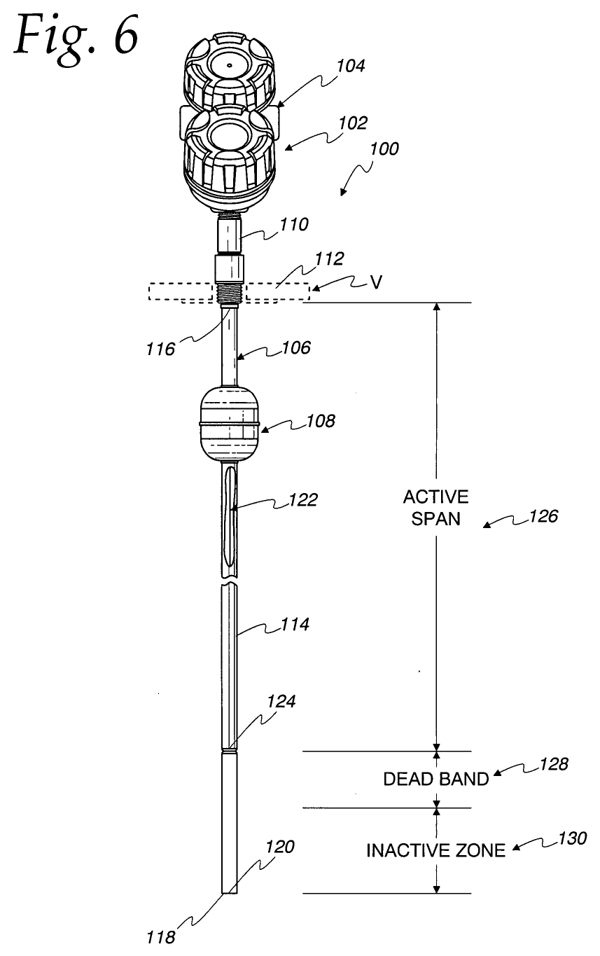

Referring to FIG. 5 and 6, a float level sensing system 100 in accordance with a second embodiment of the invention for measuring level of the process material M in the vessel V is illustrated. A transmitter 102 includes a control housing 104 and a probe 106. A float 108 comprises a magnetic float captured on the probe 106. The float 108 rides up and down the probe 106, as is known, with the material surface. A coupling 110 connects the probe 106 to the housing 104. The coupling 110 is threaded into a flange 112 of the vessel V.

The probe 106 comprises a tube 114 having a near end 116 connected to the coupler 110 and a distal end 118 closed by an end cap 120. The end cap 120 is enlarged to prevent the float 108 from falling off the probe 106. The tube 114 receives a magnetostrictive wire 122, as above. The magnetostrictive wire 122 is connected to a measuring circuit in the control housing 104. The measuring circuit will be identical to the measuring circuit 38, discussed above.

In accordance with the invention, the tube 114 includes an annular ridge 124 which indicates location of a conventional fixture at a lower end for the magnetostrictive wire 122. The ridge 124 is located at an intermediate position between the near end 116 and the distal end 118. Thus, the probe defines an active span 126 between the near end 116 and the ridge 124 representing a range where level is being measured; a dead band 128 just below the ridge 124 where the magnetic field of the float will be sufficient to be measured by the wire 122 but not indicate any change in level, and an inactive zone 130 wherein the magnetic field of the float 108 is out of range and will not be sensed by the magnetostrictive wire 122. The level sensing system 100 is designed so that the float 108 would only enter the inactive zone 130 upon failure of the float.

The operation of the level sensing system 100 is similar to that discussed above relative to FIGS. 3 and 4. Particularly, the transmitter 102 indicates a no float fault if the float 108 is positioned in the inactive zone, out of sensing range of the wire 122.

The transmitters 32 and 102 described above comprise magnetostrictive transmitters. As will be apparent, other types of transmitters could also be used for sensing the magnetic field of the magnetic float.

The present invention has been described with respect to flowcharts and block diagrams. It will be understood that each block of the flowchart can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

Thus, in accordance with the invention, the float level sensing system for measuring level of a process material includes float diagnostics which indicate a fault condition responsive to a float being outside a sensing region of a probe.

I claim:

1. A float level sensing system for measuring level of a process material and including float diagnostics, comprising:
a float;
an elongated probe for sensing position of the float;
means for mounting the float proximate the probe so that the float floats atop the process material, said mounting means enabling the float to drop outside a sensing region of the probe responsive to a failure of the float; and
a sensing circuit operatively associated with the probe for measuring a characteristic of the probe representing position of the float and being operative to indicate a fault condition responsive to the float being outside the sensing region of the probe.

2. The float level sensing system of claim 1 wherein the float comprises a magnetic float and the probe senses a magnetic field of the float.

3. The float level sensing system of claim 2 wherein the probe comprises a magnetostrictive wire.

4. The float level sensing system of claim 3 wherein the probe comprises a tube having a near end and a distal end and the tube supports the wire.

5. The float level sensing system of claim 4 wherein the mounting means comprises the float being carried on the tube and a distal end of the wire is spaced from the distal end of the tube so that if the float is at the distal end of the tube the float is out of range of the wire.

6. The float level sensing system of claim 1 wherein the mounting means comprises a chamber receiving the float and supporting the probe and wherein the chamber extends below the probe so that if the float is at a lower end of the chamber the float is out of range of the probe.

7. A float level sensing system for measuring level of a process material and including float diagnostics, comprising:
an elongated probe for sensing a magnetic field, the probe having a near end and a distal end and defining a select sensing range ending at an intermediate position between the near end and the distal end;
a magnetic float carried on the probe between the near end and the distal so that the float floats atop the process material, the float drops outside the select sensing range of the probe responsive to a failure of the float; and
a sensing circuit operatively associated with the probe for measuring a characteristic of the probe representing position of the float and being operative to indicate a fault condition responsive to the float being outside the select sensing range of the probe.

8. The float level sensing system of claim 7 wherein the probe comprises a magnetostrictive wire.

9. The float level sensing system of claim 8 wherein the probe comprises a tube supporting the wire and carrying the float, the tube defining the ends of the probe.

10. The float level sensing system of claim 9 wherein a distal end of the wire is spaced from the distal end of the tube so that if the float is at the distal end of the tube the float is out of range of the wire.

11. A float level sensing system for measuring level of a material in a process vessel and including float diagnostics, comprising:
a chamber for mounting to the process vessel and having an elongated interior space receiving the material;
a magnetic float in the chamber so that the float floats atop the material, the float dropping to a bottom portion of the chamber responsive to a failure of the float;
an elongated probe mounted to the chamber for sensing a magnetic field, the probe having a near end and a distal end, the distal end being above the bottom portion of the chamber so that the bottom portion is outside a select sensing range of the probe; and
a sensing circuit operatively associated with the probe for measuring a characteristic of the probe representing position of the float and being operative to indicate a fault condition responsive to the float being outside the select sensing range of the probe.

12. The float level sensing system of claim 11 wherein the probe comprises a magnetostrictive wire.

13. The float level sensing system of claim 12 wherein a distal end of the wire is positioned proximate the distal end of the tube so that if the float is below the distal end of the tube the float is out of range of the wire.
